(19) United States
(12) Patent Application Publication
(10) Pub. No.: US 2019/0307103 A1
(43) Pub. Date: Oct. 10, 2019

(54) Method for Producing an Animal Treat

(71) Applicant: Triumph Foods, LLC, St. Joseph, MO (US)

(72) Inventors: Barry S. Wiseman, Olathe, KS (US); Mathew A. England, Roeland Park, KS (US); Jerry L. Logston, II, Easton, MO (US); Frank T. Papenburg, St. Joseph, MO (US); Emily Arkfeld, St. Joseph, MO (US)

(21) Appl. No.: 16/379,376

(22) Filed: Apr. 9, 2019

Related U.S. Application Data
(60) Provisional application No. 62/655,547, filed on Apr. 10, 2018.
(60) Provisional application No. 62/675,260, filed on May 23, 2018.

(51) Int. Cl. A01K 15/02; A23K 10/26

(52) U.S. Cl. CPC A01K 15/025; A23K 10/30; A23K 10/26

(57) ABSTRACT

The disclosure relates to methods of producing pet treats, and pet treats produced therefrom. In one embodiment, the pet treat is produced from fresh, porcine lungs. In one embodiment, the pet treat is produced from a single ingredient. In still another embodiment, the pet treat is produced from a method that employs multiple heating steps.

### CROSS-REFERENCE TO RELATED APPLICATIONS

This application claims priority to and is a non-provisional application of Provisional Application No. 62/655,547 filed Apr. 10, 2018 and Provisional Application No. 62/675,260 filed May 23, 2018, both of which are incorporated herein by reference in their entirety.

### FIELD

The disclosure relates to a method for producing an animal treat from an animal product. In one embodiment, the method produces an animal treat from a single ingredient, such as porcine lungs. In one embodiment, the method uses multiple temperatures to produce an animal treat from fresh porcine lung.

### BACKGROUND

Pets, such as dogs and cats, are known to bite, scratch, gnaw, lick and chew upon objects, particularly items such as natural bones or other objects such shoes, furniture and other household items causing unwanted damage to these items. As an answer to this problem, the pet industry has developed natural and synthetic chew toys that are manufactured in various shapes and sizes for dogs and other pets to chew on.

Pet owners have a variety of commercially available pet treats to choose from, including rawhide, jerky treats, and biscuits. Two types of treats are: (1) animal or meat product derivatives, and (2) starch based products that include meat palatability enhancers. Both treat types have a meat based flavor to which cats and dogs are attracted. Generally, meat or poultry broth concentrate or powder, such as liver digest, function as a palatability enhancer in starch based pet treats. Thus, meat and meat flavored treats are available that are desired by consumers.

Starch based pet treats, however, suffer from a number of drawbacks including being brittle or hard. The starch treats also have a tendency to become hard after the treat has been removed from its packaging. Harder pet treats are difficult for pets to chew and may not be desirable to pets having sensitive teeth or gums.

In addition, such hard materials can break the pet's teeth or cause splinters that can affect the digestive track. Very young and old pets that may not have strong teeth prefer to chew on softer toys made from plastic, rubber or other elastomers. Although these toys are long lasting and durable, they fail to hold the pet's interest for long owing to the lack of flavor or texture.

Attempts have also been made to develop toys that attract pets, such as providing toys in various shapes and sizes so as to allow the pets to hold, pick, chew or even play with them, thus providing a means for maintaining interest in the toy. However, some of these pet chew toys can be easily swallowed and can be a choking hazard or even cause bowel obstruction in pets. Some of the chew toys available in the market tout benefits such as serving to distract the pet from chewing on other objects or to clean the teeth of pets, providing for dental hygiene and resulting in better breath.

Thus, a need still exits for a treat for pets that is easily consumed and has a texture and consistently suitable for young and small animals.

### SUMMARY

In one embodiment, the disclosure relates to an animal treat produced from an animal product. In one embodiment, the animal product is a fresh, porcine lung.

In one embodiment, the animal treat has porcine lung as the only ingredient of the animal treat. In one embodiment, the animal treat is less dense as compared to traditional animal treats. In one embodiment, the animal treat is a pet treat.

In one embodiment, the disclosure relates to a method for producing a pet treat. In one embodiment, the method uses a single ingredient for production of the pet treat.

In one embodiment, the disclosure relates to a method for producing a pet treat from fresh porcine lung, wherein the micro-alveoli structure of the lungs is maintained.

In one embodiment, the disclosure relates to a method of producing a pet treat from lungs that were not frozen. In one embodiment, the disclosure relates to a method of producing a pet treat from lungs that were not exposed to flash freezing. In one embodiment, the disclosure relates to a method of producing a pet treat from lungs that were not exposed to cold storage after washing the lungs. In one embodiment, the disclosure relates to a method of producing a pet treat from lungs that were not exposed to cold storage prior to washing the lungs.

In one embodiment, the disclosure relates to a method for producing a pet treat comprising removing fresh porcine lungs from the lung line; washing the fresh lungs in a cold water bath; slicing the lungs; exposing the sliced lungs to a first temperature ranging from 205° C. to 210° C. for at least 15 minutes; exposing the cubes to a second temperature ranging from 70° C.-75° C. for 6-8 hours as established by water activity (dehydration step). In one embodiment, after dehydration, the product is cooled to room temperature and ready for packaging.

In one embodiment, the disclosure relates to a method for producing a pet treat comprising: slicing fresh porcine lungs, wherein the porcine lungs were exposed to a cold water bath prior to slicing; exposing the sliced lungs to a first temperature ranging from 205° C. to 210° C. for at least 15 minutes; exposing the sliced lungs to a second temperature from 70° C.-75° C. ranging for six to eight hours (dehydration step). In one embodiment, after dehydration, the product is cooled to room temperature and ready for packaging.

In one embodiment, the disclosure relates to a method for producing a pet treat comprising: exposing fresh porcine lungs to a first temperature from 205° C. to 210° C. for at least 15 minutes; dehydrating the heated fresh porcine lungs at a second temperature from 70° C. to 75° C. for a time period ranging from six to eight hours. In one embodiment, after dehydration, the product is cooled to room temperature and ready for packaging.

In one embodiment, the disclosure relates to a method for producing a pet treat comprising: exposing fresh porcine lungs to a first temperature from 205° C. to 210° C.; exposing the heated fresh porcine lungs to a second temperature, wherein the second temperature is lower than the first temperature.

In one embodiment, the disclosure relates to a method for producing a pet treat comprising: (a) heating porcine lungs that were not frozen for at least 15 minutes, wherein the heating occurs at a temperature from about 205° C. to about 210° C.; and (b) dehydrating the lungs of step (a) to produce a pet treat.

In one embodiment, the disclosure relates to a pet treat having a density from about 0.22 to about 0.32 g/cm³.

In one embodiment, the disclosure relates to a pet treat having a shear force from about 10 to about 15 Pa.

In still another embodiment, the disclosure relates to a pet treat having an “L” value on the Hunter scale from about 65 to about 85. In one embodiment, the pet treat produced herein has an “a” value on the Hunter scale from about 15 to about 35. In one embodiment, the pet treat produced herein has a “b” value on the Hunter scale from about 30 to about 50.

In one embodiment, the disclosure relates to a pet treat having a reduced pathogen load. In one embodiment, the pet treat has a reduced microorganism load. In one embodiment, the pet treat has a reduced bacterial load. In another embodiment, the pet treat has a reduced viral load.

An advantage of the methods and products produced therefrom is in the product texture, consistency and safety.

An advantage of the methods and products produced therefrom is a consistently less dense product readily consumed by young companion animals, old companion animals, small companion animals including but not limited to dogs and cats.

An advantage of the methods and products produced therefrom is that the methods include a physical antimicrobial step that should provide increased safety.

### BRIEF DESCRIPTION OF THE DRAWINGS

FIG. 1 is a photograph of lungs that underwent Treatment 1 as described in Example 1.

FIG. 2 is a photograph of lungs that underwent Treatment 2 as described in Example 1.

FIG. 3 is a photograph of lungs that underwent Treatment 3 as described in Example 1.

FIG. 4 is a photograph of lungs that underwent treatment 4 as described in Example 1.

FIG. 5 is a photograph of lungs that underwent Treatment 6 as described in Example 1.

### DETAILED DESCRIPTION

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

### Definitions

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, molecular weight, viscosity, etc., is from 100 to 1,000, it is intended that all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, temperatures for heating a product.

As used herein, “a,” “an,” or “the” can mean one or more than one. For example, “a” lung can mean a single lung or a multiplicity of lungs.

The term “and/or” as used in a phrase such as “A and/or B” herein is intended to include both A and B; A or B; A (alone); and B (alone). Likewise, the term “and/or” as used in a phrase such as “A, B, and/or C” is intended to encompass each of the following embodiments: A, B, and C; A, B, or C; A or C; A or B; B or C; A and C; A and B; B and C; A (alone); B (alone); and C (alone).

As used herein, the term “adjuvant” refers to an ingredient capable of imparting to an aroma (e.g., a carrier/flavoring mixture) an additional benefit such as color, a particular light resistance, chemical stability, and so on. Appropriate adjuvants that are commonly used in aroma synthesis are well known to a person skilled in the art.

As used herein, the term “about” when referring to a measurable value such as an amount, a temporal duration, and the like, is meant to encompass variations of +/−20%, more preferably +/−10%, even more preferably +/−5% from the specified value, as such variations are appropriate to reproduce the disclosed methods and products.

As used herein, the term “animal digest” refers to material that results from chemical and/or enzymatic hydrolysis of clean, undecomposed animal tissue. In some embodiments, an animal digest as used herein is fully consistent with the definition promulgated by the Association Of American Feed Control Officials, Inc. (AAFCO).

As used herein, the term “carrier” refers to a usually inactive substance that is used in association with an active compound or mix of compounds. Under these circumstances, a “carrier” typically aids the application of said active compound or mix of compounds. In one embodiment, a “carrier” refers to a material that is substantially neutral from an odor or flavor point of view, insofar as it does not significantly alter the essential organoleptic properties of flavorings.

Alternatively, the term “carrier” can refer to a “carrier for concentrating” or “carrier for drying,” encompassing conventional compounds that are well-known in the art to perform a concentration or a drying step in a given method. Examples of “carriers for concentrating” or “carriers for drying” are microbial proteins (e.g., yeasts), animal proteins, vegetable proteins, carbohydrates (e.g., maltodextrin, cyclodextrin), as well as minerals or inorganic compounds, including inorganic phosphate compounds.

As used herein, a “coloring agent” refers to any substance of natural origin or any synthetic color that is suitable (preferably certified) for use in pet food. Coloring agents are useful to, inter alia, compensate for color changes during processing or to give an appetizing color to an edible product.

As used herein, the term “fish” encompasses any species or kind of fish or crustaceans or molluscs, preferably tuna, salmon, cod, hake, sardine, shrimp, squid, and the like.

As used herein, the term “food” or “food product” as used herein refers to a product or composition that is intended for ingestion by an animal and provides at least one nutrient to the animal. The term “food” includes any food, feed, snack, food supplement, treat, meal substitute, or meal replacement. “Food” encompasses such products in any form, solids, liquids, gels, or mixtures or combinations thereof.

As used herein, the term “microorganism” is intended to encompass organisms that are generally unicellular including but not limited to, Gram-positive; or Gram-negative bacteria, yeasts, molds, parasites, and mollicutes. Non-limiting examples of Gram-negative bacteria of include bacteria of the following genera: Pseudomonas, Escherichia, Salmonella, Shigella, Enterobacter, Klebsiella, Serratia, Proteus, Campylobacter, Haemophilus, Morganella, Vibrio, Yersinia, Acinetobacter, Stenotrophomonas, Brevundimonas, Ralstonia, Achromobacter, Fusobacterium, Prevotella, Branhamella, Neisseria, Burkholderia, Citrobacter, Hafnia, Edwardsiella, Aeromonas, Moraxella, Brucella Pasteurella, Providencia, and Legionella. Non-limiting examples of Gram-positive bacteria include bacteria of the following genera: Enterococcus, Streptococcus, Staphylococcus, Bacillus, Paenibacillus, Lactobacillus, Listeria, Peptostreptococcus, Propionibacterium, Clostridium, Bacteroides, Gardnerella, Kocuria, Lactococcus, Leuconostoc, Micrococcus, Mycobacteria and Corynebacteria. Non-limiting examples of yeasts and molds include those of the following genera: Candida, Cryptococcus, Nocardia, Penicillium, Alternaria, Rhodotorula, Aspergillus, Fusarium, Saccharomyces and Trichosporon. Non-limiting examples of parasites include those of the following genera: Trypanosoma, Babesia, Leishmania, Plasmodium, Wucheria, Brugia, Onchocerca, and Naegleria.

As used herein, the terms “pet” and “companion animal” are synonymous and refer to any that could benefit from or enjoy the compositions disclosed herein. In one embodiment, a pet or companion animal is a domesticated animal including, without limitation, cats, dogs, rabbits, guinea pigs, ferrets, hamsters, mice, gerbils, birds, horses, cows, goats, sheep, donkeys, pigs, and the like.

As used herein, the term “palatability” refers to a relative preference of an animal for one food product to another. Palatability refers to the overall willingness of an animal to eat a certain food product. In one embodiment, palatability further refers to the capacity of the eaten food product to satisfy the animal. Whenever an animal shows a preference, for example, for one of two or more food products, the preferred food product is more “palatable” and has “enhanced palatability.”

The relative palatability of one food product compared to one or more other food products can be determined, for example, in side-by-side, free-choice comparisons, e.g., by relative consumption of the food products, or other appropriate measures of preference indicative of palatability. It can be determined by a standard testing protocol in which the animal has equal access to both food products such as a test called “two-bowl test” or “versus test.” An alternative can be the “one bowl test” or “monadic test” in which only one bowl of food is offered to the animal. With this methodology, some criteria linked to palatability are recorded such as intake of food, percentage of animals having totally consumed the food, percentage of animals having refused the food (food not at all eaten), rate of consumption. Such preference can arise from any of the animal's senses, but typically is related to, inter alia, taste, aftertaste, smell, mouth feel and/or texture.

A pet food product stated herein to have “enhanced palatability” is one for which a pet exhibits preference relative to a control food product. In one embodiment, a pet food product has two major advantages: it has enhanced palatability to pets and it is appealing to pet owners.

As used herein, “poultry” encompasses any species or kind of bird, preferably chicken, turkey, duck, and the like.

As used herein, the term “treat” refers to any food item that is designed to be fed to a pet, preferably at non-meal time. Examples of treats are bones, rawhides, sticks, pillows, biscuits, and the like. Treats may be nutritional or not, entirely or partially consumable (e.g., consumable toys).

As used herein, a “texturing agent” or “texturizing agent” or “stabilizing agent” is an ingredient that affects the texture or the mouthfeel of an edible product, e.g., a component that increases the viscosity of an edible product. Examples thereof are xanthan, alginate, carragheenans, guar gum, Arabic gum, and the like.

As used herein, the term “virus” means virus that can cause a disease in humans or animals.

### I. Method for Producing an Animal Treat

In one embodiment, the disclosure relates to a method of producing an animal treat. In one embodiment, the animal treat is produced from fresh lung from a slaughtered animal. In one embodiment, the method of producing the animal treat maintains the micro-alveoli structure of the lungs. In one embodiment, the method of producing the animal treat maintains the alveoli structure of the lungs.

In one embodiment, the disclosure relates to a method for producing a pet treat comprising: exposing fresh animal product to a first temperature; and exposing the heated animal product from step (a) to a second temperature, wherein the second temperature is lower than the first temperature.

In one embodiment, the disclosure relates to a method for producing a pet treat comprising: heating fresh animal product, wherein heating occurs at a first temperature from 205° C. to 210° C.; and dehydrating the heated animal product from step (a) using a second temperature, wherein the second temperature is lower than the first temperature.

In yet another embodiment, the disclosure relates to a method for producing a pet treat comprising: (a) exposing fresh animal product to a first temperature from 205° C. to 210° C. for at least 15 minutes; and (b) exposing the heated animal product from step (a) to a second temperature from 70° C. to 75° C. for a time period for at least 6 hours.

In yet another embodiment, the disclosure relates to a method for producing a pet treat comprising: (a) heating fresh animal product, which has never been frozen, for at least 15 minutes, wherein heating occurs at a first temperature from 205° C. to 210° C.; and (b) dehydrating the heated animal product from step (a) at a second temperature from 70° C. to 75° C. for a time period for at least 8 hours.

In still another embodiment, the disclosure relates to a method for producing a pet treat comprising: (a) manipulating animal product to a desired shape, wherein the animal product was exposed to a cold water bath prior to manipulating; (b) exposing the animal product from step (a) to a first temperature from 205° C. to 210° C. for at least 15 minutes; and (c) exposing the animal product from step (b) to a second temperature from 70° C.-75° C. for a time period for at least 6 hours.

In still another embodiment, the disclosure relates to a method for producing a pet treat comprising: (a) manipulating animal product to a desired shape, wherein the animal product was exposed to a cold water bath prior to manipulating; (b) heating the animal product from step (a) for no more than 2 hours; and (c) dehydrating the animal product from step (b) at a second temperature from 70° C.-75° C. for a time period of at least 8 hours.

In yet another embodiment, the disclosure relates to a method for producing a pet treat comprising: (a) removing animal product from a slaughtered animal; (b) washing the animal product in a cold water bath; (c) slicing the animal product; (d) exposing the sliced animal product to a first temperature from 205° C. to 210° C. for at least 15 minutes; and (e) exposing the animal product from step (d) to a second temperature from 70° C.-75° C. for at least 6 hours.

In yet another embodiment, the disclosure relates to a method for producing a pet treat comprising: (a) removing animal product from a slaughtered animal; (b) washing the animal product in a cold water bath; (c) slicing the animal product; (d) heating the sliced animal product for at least 15 minutes, wherein heating occurs at a first temperature from 205° C. to 210° C.; and (e) dehydrating the animal product from step (d) at a second temperature from 70° C.-75° C. for at least 8 hours.

A. Animal Product

In one embodiment, the disclosure relates to methods for producing a pet treat from an animal product. In one embodiment, the pet treat is for a companion animal. In one embodiment, the pet treat is for livestock. In one embodiment, the pet treat is for a canine or feline.

In one embodiment, the animal product is derived from any suitable animal including but not limited to poultry, including chickens, turkeys, cows, including dairy cows and beef cows, porcine animals, including pigs and hogs, sheep, fish, ostrich, buffalo, water buffalo, steer and bull. In one embodiment, the animal product is derived from a pig or a hog.

In one embodiment, the animal product is a lung or a kidney, or a brain, or a heart, or a liver, or a stomach, or an intestine (freed of all or essentially all their contents), or cartilage, or organ tissue, or muscle tissue, or bone tissue, or a snout, or an ear or combinations thereof. The animal product can be intact, almost completely hydrolyzed, or partially hydrolyzed. Generally, the animal product is obtained from a slaughter house.

In one embodiment, the animal product is a lung. In one embodiment, the lung is fresh. In one embodiment, the lung has not been frozen.

In one embodiment, the lung is processed, partially or completely, within 24 hours of slaughtering the animal. In yet another embodiment, the lung is processed, partially or completely, within 12 hours of slaughtering the animal. In still another embodiment, the lung is processed, partially or completely, within 6 hours of slaughtering the animal. In yet another embodiment, the lung is processed, partially or completely, within 3 hours of slaughtering the animal. In another embodiment, the lung is processed, partially or completely, within 1 hour of slaughtering the animal.

In one embodiment, the pet treat is a single ingredient or component pet treat. In one embodiment, porcine lung is the only ingredient of the pet treat. In one embodiment, porcine lung is the only protein ingredient of the pet treat. In one embodiment, porcine lung is the only meat ingredient of the pet treat.

B. Washing the Animal Product

In one embodiment, the animal product is removed from a slaughtered animal within 30 minutes or 1 hour or 2 hours, or 3 hours or 4 hours from when the animal was slaughtered.

In one embodiment, fresh lungs are removed from an animal at the lung line. In one embodiment, the lungs are removed from the animal within 30 minutes or 1 hour or 2 hours, or 3 hours or 4 hours from when the animal was slaughtered.

In one embodiment, the fresh lungs are washed/chilled in a cold water bath. The fresh lungs are placed in the water bath within 30 minutes, or 1 hour, or 2 hours, or 3 hours, or 4 hours from removal of the lung line.

In one embodiment, the fresh lungs are placed in a water bath within five hours after removal from the lung line. In one embodiment, the fresh lungs are placed in a water bath within 15 minutes to four hours after removal from the lung line. In yet another embodiment, the fresh lungs are placed in a water bath in a sufficient time period to maintain the alveoli within the lungs.

In one embodiment, the fresh lungs are placed in a water bath having a temperature from about 0° C. to about 10° C. In one embodiment, the temperature of the water bath is less than 15° C. In one embodiment, the temperature of the water bath is less than 25° C.

C. Manipulating the Washed Animal Product

In one embodiment, the washed animal product is manipulated into a desired shape and size. In one embodiment, the animal product can be manipulated using any suitable method including but not limited to cutting, slicing, chopping, grinding, and dicing.

In one embodiment, the animal product can be manipulated into any desired shape, including but not limited to a square, a rectangle, or a cube. In one embodiment, the animal product can be manipulated into a cube. In one embodiment, the cube is from 1 to 8 cm length on each end.

In one embodiment, after washing, the fresh lungs are sliced into a manageable size. In one embodiment, the fresh lungs are sliced into cubes. In yet another embodiment, the fresh lung cubes are from 2 to 4 cm length on each end.

D. Heating the Animal Product

In one embodiment, the animal product is heated, wherein the heating occurs at a first temperature. In one embodiment, the animal product is exposed to a heating source set at a first temperature. In one embodiment, the first temperature ranges from 180° C. to 250° C. In one embodiment, the first temperature is about 200° C., or about 205° C., or about 210° C., or about 215° C.

In one embodiment, the first temperature is at least 200° C. In one embodiment, the first temperature is a suitable temperature to maintain the micro-alveoli structure within the lungs.

In one embodiment, the animal product is exposed to the first temperature for a first period of time. In one embodiment, the first period of time ranges from 15 minutes to 2 hours. In another embodiment, the first period of time ranges from 30 minutes to 1 hour. In one embodiment, the first period of time is at least 10 minutes. In one embodiment, the first period of time is at least 15 minutes and no longer than 90 minutes.

In yet another embodiment, the first period of time is no longer than 5 hours, or 4 hours, or 3 hours, or 2 hours or 1 hour. In one embodiment, the first period of time is less than 1 hour or less than 45 minutes.

In one embodiment, the animal product is exposed to the first temperature using an impingement oven. Not to be bound by any particular theory, an impingement oven uses the principles of forced air movement to heat the animal product. The animal product is surrounded by forced hot air that “impinges” or affects the surface of the food. This air moves at a high speed, breaking through the cooler thermal boundaries of the animal product. In an impingement oven, jet nozzles direct the heat more specifically to the product, increasing the flow of heat.

In one embodiment, the animal product is exposed to the first temperature using an air fryer. Not to be bound by any particular theory, an air fryer cooks by circulating hot air around the animal product. Typically, a mechanical fan circulates the hot air around the animal product at high speed, cooking the food and producing a crispy layer via the Maillard effect.

E. Dehydrating the Animal Product

In one embodiment, after heating the animal product, the animal product is dehydrated. In one embodiment, dehydration occurs at a second temperature lower than the first temperature that was used to heat the animal product.

In one embodiment, the animal product is exposed to a second temperature, wherein the second temperature is lower than the first temperature. In one embodiment, the animal product is exposed to the second temperature after exposure to the first temperature.

In one embodiment, there is a period of time between exposing the animal product to the first temperature (heating) and the second temperature (dehydration) including but not limited to 15 minutes, 30 minutes, 1 hour, 2 hours, 3 hours, 4 hours, 5 hours, 6 hours, 7 hours, 8 hours, 9 hours, 10 hours and greater than 10 hours.

In one embodiment, the time between exposing the animal product to the first temperature and the second temperature is less than 5 hours or less than 4 hours or less than 3 hours.

In one embodiment, the second temperature ranges from about 60° C. to about 90° C. In one embodiment, the second temperature is at least about 70° C. In yet another embodiment, the second temperature ranges from about 70° C. to about 75° C.

In one embodiment, the animal product is exposed to the second temperature for a second period of time, wherein the second period of time is longer than the first period of time.

In one embodiment, the second period of time ranges from about 2 to about 12 hours. In yet another embodiment, the second period of time ranges from about 4 to about 10 hours. In still another embodiment, the second period of time ranges from about 6 to about 8 hours as established by water activity.

In one embodiment, the second temperature is supplied by a low temperature dehydrator or roaster.

In one embodiment, the animal product is dehydrated for at least 6 hours. In yet another embodiment, the animal product is dehydrated from 8 to 10 hours. In still another embodiment, the animal product is dehydrated for no more than 12 hours.

After dehydration, the product is cooled to room temperature and ready for packaging.

### II. Pet Treat

A. Characteristics

In one embodiment, the pet treat produced using methods disclosed herein has enhanced texture, consistency, palatability, and safety. The methods described herein produce a consistently less dense product readily consumed by companion animals including but not limited to young companion animals, small companion animals, and elderly companion animals. The pet treat is visibly different from other products and has antimicrobial properties that provide increased safety.

1. Density

In one embodiment, the pet treat produced herein has a density from about 0.22 to about 0.32 g/cm³. In one embodiment, the pet treat produced herein has a density from about 0.25 to about 0.30 g/cm³. In yet another embodiment, the pet treat produced herein has a density from about 0.27 to 0.29 g/cm³.

In yet another embodiment, the pet treat produced herein has a density less than 0.32 g/cm³. In still another embodiment, the pet treat produced herein has a density of at least 0.22 g/cm³.

2. Shear Force

Shearing forces are unaligned forces pushing one part of a body in one specific direction, and another part of the body in the opposite direction. When the forces are aligned into each other, they are called compression forces.

In one embodiment, the pet treat produced herein has a shear force from about 10 to about 15 Pa. In one embodiment, the pet treat produced herein has a shear force of at least 10 Pa. In yet another embodiment, the pet treat produced herein has a shear force no greater than about 15 Pa.

3. Color

In one embodiment, the pet treat produced herein has superior color characteristics. Hunter L, a, b is a color scale based on the Opponent-Color Theory. This theory assumes that the receptors in the human eye perceive color as the following pairs of opposites.

L scale: Light vs. dark where a low number (0-50) indicates dark and a high number (51-100) indicates light;

a scale: Red vs. green where a positive number indicates red and a negative number indicates green;

b scale: Yellow vs. blue where a positive number indicates yellow and a negative number indicates blue.

The “L” value indicates the level of light or dark, the “a” value redness or greenness, and the “b” value yellowness or blueness.

In one embodiment, the pet treat produced herein has an “L” value on the Hunter scale of at least 65. In another embodiment, the pet treat produced herein has an “L” value on the Hunter scale of about 75.

In one embodiment, the pet treat produced herein has an “L” value from about 65 to about 85. In yet another embodiment, the pet treat produced herein has an “L” value from about 65 to about 80. In yet another embodiment, the pet treat produced herein has an “L” value from about 65 to about 75.

In one embodiment, the pet treat produced herein has an “a” value on the Hunter scale of at least 15. In one embodiment, the pet treat produced herein has an “a” value from about 15 to about 35. In one embodiment, the pet treat produced herein has an “a” value from about 15 to about 30. In one embodiment, the pet treat produced herein has an “a” value from about 15 to about 25. In one embodiment, the pet treat produced herein has an “a” value from about 15 to about 20.

In one embodiment, the pet treat produced herein has a “h” value on the Hunter scale of at least 30. In one embodiment, the pet treat produced herein has a “b” value from about 30 to about 50. In one embodiment, the pet treat produced herein has a “b” value from about 30 to about 45. In one embodiment, the pet treat produced herein has a “b” value from about 30 to about 40. In one embodiment, the pet treat produced herein has a “b” value from about 30 to about 35.

In still another embodiment, the pet treat produced herein has a “b” value of about 35.

In one embodiment, the pet treat produced herein has an “L” value of at least 60, an “a” value of at least 15, and a “b” value of at least 30, with “I” “a,” and “b” all on the Hunter scale.

4. Microorganisms/Viruses

In one embodiment, the pet treat produced herein has a reduced level of microorganisms as compared to conventional pet treats. In one embodiment, the pet treat produced herein has a reduced level of pathogens as compared to a conventional pet treat. In still another embodiment, the pet treat produced herein has a reduced level of viruses as compared to a conventional pet treat.

In one embodiment, the pet treat produced herein has a reduced pathogen load as compared to conventional pet treats.

In one embodiment, the pet treat produced herein has a pathogen load that is at least 10% lower as compared to a conventional pet treat.

In one embodiment, the pet treat produced herein has a pathogen load that is about 10 to about 30% lower as compared to a conventional pet treat.

In one embodiment, the pet treat produced herein has a viral load that is reduced by four-fold as compared to a conventional pet treat or a pet treat not exposed to a first and second temperature.

In one embodiment, the pet treat produced herein has a viral load that is reduced by at least two-fold or at least three-fold as compared to a conventional pet treat or a pet treat not exposed to a first and second temperature.

In one embodiment, the pet treat produced herein lacks detectable parvovirus as compared to a conventional pet treat or a pet treat not exposed to a first temperature and a second temperature.

B. Preservative

In one embodiment, the disclosure relates to a pet treat produced using the methods described herein with at least one preservative. In one embodiment, the animal product can be mixed with a preservative at any state of the process including but not limited to washing; manipulating; exposing to the first temperature, exposure to the second temperature; after the cooling process and prior to packing. A preservative can be introduced at one step or multiple steps in the process described above.

Preservatives are in particular used for ensuring a long shelf life of a food product or a food composition. Preservatives comprise natural or synthetic anti-oxidants (such as BHA, BHT, propyl gallate, octyl gallate, tocopherols, rosemary extracts, and the like); as well as sorbic acid or sorbic salts (e.g., potassium sorbate), and other acids like phosphoric acid and the like. “Surfactants” are molecules that are surface active. They typically have a hydrophilic portion (e.g., one or more head groups) and a hydrophobic (or lipophilic) portion (e.g., one or more tails). They are classified in various ways, for example according to their hydrophilic-lipophilic balance (HLB). They can also or alternatively be classified as non-ionic, ionic or zwitterionic compounds based on the presence or absence of formally-charged in the head group(s). Surfactants are well-known in the art. One can cite, for example, Tween™, surfactants. Surfactants include, without limitation, emulsifiers and wetting agents. In some instances, the terms “surfactants” and “emulsifiers” can be used interchangeably.

C. Pet Treat with Additional Animal Compositions

In one embodiment, the pet treat can be mixed with another desired flavoring that will appeal to the animal. In one embodiment, the pet treat is mixed with a meat flavoring. In one embodiment, the pet treat is mixed with bacon or a bacon flavoring. In still another embodiment, the pet treat is mixed with an animal digest.

Animal digest is preferably derived from animal tissues as well as fish tissues, excluding hair, horns, teeth, hooves, and feathers. The skilled artisan will appreciate that while such excluded tissues are not preferred, trace amounts might be found unavoidably even under good manufacturing practices. Also not included are visceral contents or foreign or fecal matter, although trace contaminant amounts are sometimes present.

An animal digest may be dried or not. Typically, examples of animal digests are:

digest of poultry (or pork, beef, sheep, lamb, fish, etc.): material from poultry (pork, beef, etc.) which results from chemical and/or enzymatic hydrolysis of clean and undecomposed tissue;

digest of pork (or beef, sheep, lamb, fish, etc.) by-products: material from pork (beef, etc.) which results from chemical and/or enzymatic hydrolysis of clean and undecomposed tissue from non-rendered clean parts from cattle (pigs, sheep, lamb, etc.), other than meat and bones, for example lungs, spleen, kidneys, brain, livers, blood, optionally partially-defatted low-temperature fatty tissue, and stomachs and intestines, freed of their contents;

digest of poultry by-products: material which results from chemical and/or enzymatic hydrolysis of clean and undecomposed tissue from non-rendered clean parts of poultry, other than meat and bones, such as livers, hearts, heads, feet, and viscera. As used herein, “poultry” encompasses any species or kind of bird, preferably chicken, turkey, duck, and the like; and

digest of fish by-products: material which results from chemical and/or enzymatic hydrolysis of clean and undecomposed tissue from non-rendered clean parts from fish, other than meat and bones.

D. Pet Treat with an Aromatic to Appeal Toward a Pet Owner

In one embodiment, the pet treat can comprise one or more aromatic compounds. In one embodiment, an aromatic compound is a compound that imparts a desirable odor to a pet treat and/or to modify the particular odor of a pet treat.

In one embodiment, the aromatic compound is perceived by the olfactory sense of pet owners. It is thus regarded as the pet food product's appeal to pet owners.

In one embodiment, the aromatic compound is a flavoring. Specific examples of “flavorings” may be found in the current literature (e.g. in Fenaroli's Handbook of Flavor Ingredients, 6.sup.th Ed., 2010, CRC Press). “Flavorings” can be of natural or synthetic origin. Examples of flavorings include natural extracts such as citrus extracts (e.g., lemon, orange, lime, grapefruit, or mandarin oils), coffee, tea, mint, cocoa, and essential oils of herbs and spices. Other examples of “flavorings” include flavoring aromatics, oils, essential oils, oleoresins and extracts derived from plants, for example from leaves, flowers, fruits, roots, rhizomes, stem, and so forth. Yet other examples of “flavorings” are aromatics obtained by chemical synthesis.

In one embodiment, flavorings are present in the form of a mixture with “carriers” such as “solvents,” “adjuvants,” and/or other flavoring co-ingredients, for example those of current use in the flavor and/or food industry. Generally, all these flavoring co-ingredients belong to various chemical classes such as alcohols, aldehydes, ketones, esters, ethers, acetates, nitriles, terpenoids, nitrogenous or sulphurous heterocyclic compounds, and the like.

The “carrier” may be a liquid or a solid. As a liquid carrier, non-limiting examples include an emulsifying system (i.e., a “solvent” and a surfactant system) or a “solvent.” Non-limiting examples of suitable solvents include propylene glycol, triacetine, triethyl citrate, benzylic alcohol, ethanol, vegetable oils, and terpenes. As a solid carrier, non-limiting examples include absorbing gums or polymers, or encapsulating materials. Examples of such materials may comprise wall-forming and plasticizing materials, such as mono-, di- or trisaccharides, natural or modified starches, hydrocolloids, cellulose derivatives, polyvinyl acetates, polyvinylalcohols, proteins or pectins.

E. Pet Treat with Probiotics

In one embodiment, the pet treat produced by the methods herein can be mixed with one or more probiotics. Probiotics are live microorganisms that have, upon ingestion, a beneficial effect on a host animal by improving its intestinal microbial balance. Thereby, probiotics beneficially affect the host animal by maintaining its health and/or safety and/or well-being; and/or by preventing and/or treating specific medical conditions. The probiotics are given to facilitate a process whereby the endogenous anaerobic flora limits the concentration of potentially harmful (mostly aerobic) bacteria in the digestive tract. Examples of appropriate probiotics for use in pet food are, without limitation, lactic acid bacteria such as Lactobacillus spp., Lactococcus spp., Streptococcus spp.; as well as other types of bacteria.

In one embodiment, the pet treat produced by the methods disclosed herein can be mixed with one or more prebiotics. Prebiotics are non-digestible food ingredients that beneficially affect a host animal by selectively stimulating the growth and/or the activity of microorganisms in the digestive tract, thereby favoring maintenance and/or improvement of the host animal's health and/or safety and/or well-being. Examples of prebiotics include fructooligosaccharides (FOS), xylooligosaccharides (XOS), galactooligosaccharides (GOS), and manooligosaccharides.

### EXAMPLES

The present disclosure will be further described by reference to the following examples, which are presented for the purpose of illustration only and are not intended to limit the scope of the invention.

### Example 1

The following describes variations of treatments on porcine lungs with both photographic and micrographic results of product.

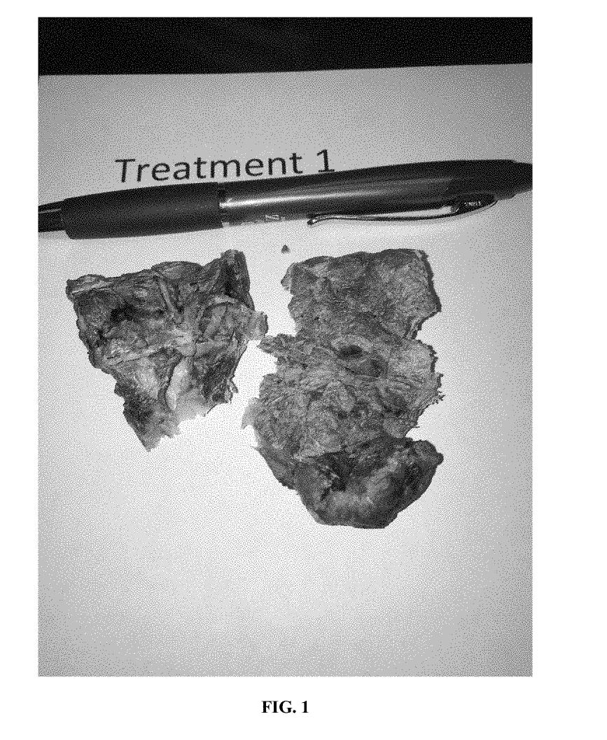

Treatment 1—Lungs were cut into 2-4 cm cubes and dried at 70° C.-75° C. for 6-8 hours. Lungs from treatment 1 are shown in FIG. 1.

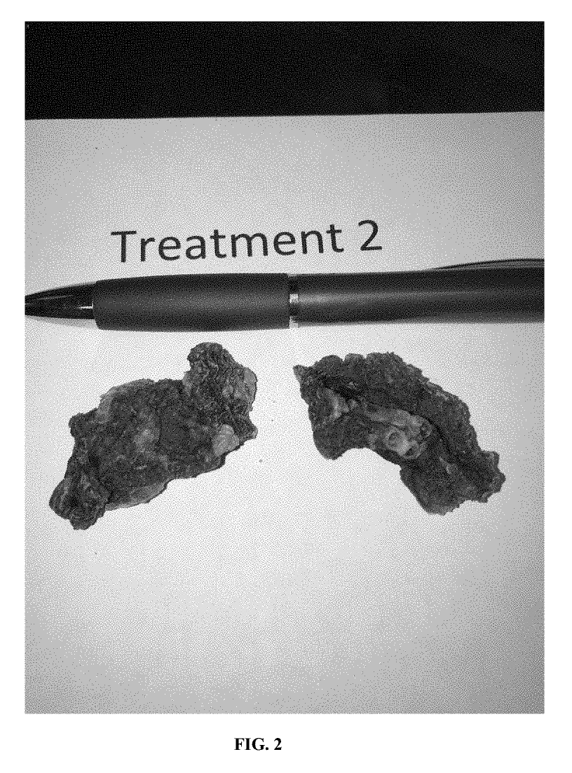

Treatment 2—Lungs were air fried to 205° C.-210° C. for a minimum of 30 minutes, sliced into cubes of 2-4 cm length on each end, then dried at 70° C.-75° C. for 6-8 hours. Lungs from treatment 2 are shown in FIG. 2.

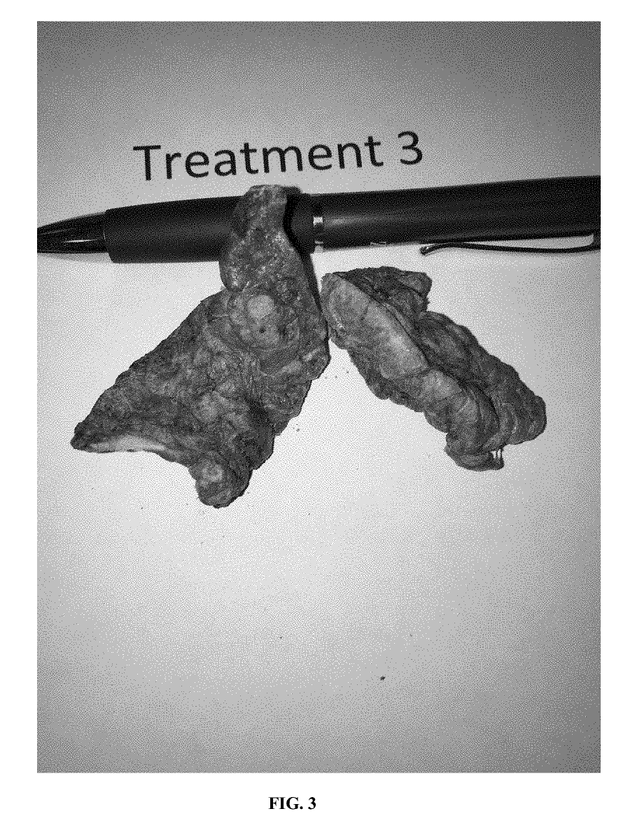

Treatment 3—Fresh lungs are removed from the lung line and washed/chilled in a cold water bath. After washing they are sliced into cubes of 2-4 cm length on each end. The cubes are moved to a rack for an impingement oven or air fryer and exposed to high velocity air heated to 205° C.-210° C. for a minimum of 30 minutes. Afterwards, the cubes are placed in a low temperature dehydrator or roaster heated to 70° C.-75° C. for 6-8 hours as established by water activity. Lungs from treatment 3 are shown in FIG. 3.

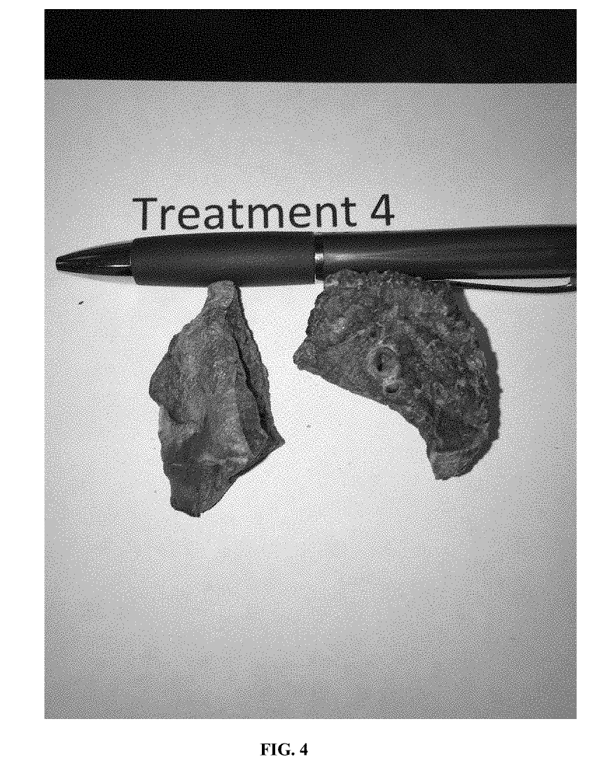

Treatment 4—Lungs were air fried to 205° C.-210° C. for a minimum of 30 minutes, sliced into cubes of 2-4 cm length on each end, then air fried to 205° C.-210° C. for a minimum of 30 minutes then dried at 70° C.-75° C. Lungs from treatment 4 are shown in FIG. 4.

Treatment 5—Lungs were frozen, cut then dried at 70° C.-75° C.

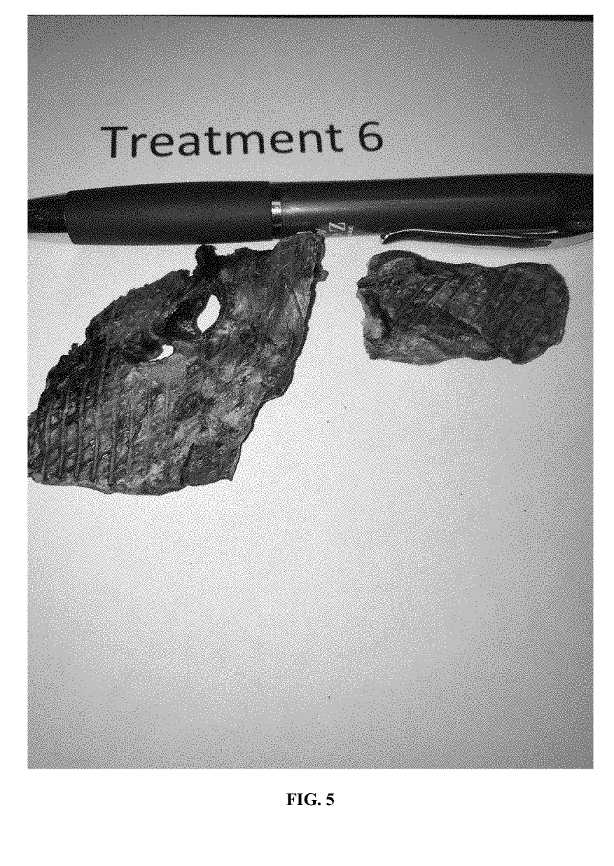

Treatment 6—Competitor product—appears to have been frozen prior to roasting. Lungs from treatment 6 are shown in FIG. 5.

### Example 2

Various methods of treating lungs from a porcine animal were evaluated. Table I provides a summary of the various methods and results.

Treatment A: Fresh lungs were dehydrated at about 71° C. for 13 hours. The resulting product had a density of 0.1322 g/cm3, and a shear force of about 4.9 Pa. The Hunter lab score was as follows: “L” value 39, “a” value of 14 and a “b” value of 24. This treatment did not produce a product with the desired properties; the shear force was too low and would not provide the desired chewing experience.

Treatment B: Lungs that were washed and cut were exposed to a temperature of about 204° C., and then exposed to a second temperature of 71° C. for 6 hours. The resulting product had a density of 0.27 g/cm3, and a shear force of about 13.9 Pa. The Hunter lab score was as follows: “L” value 74, “a” value of 15 and a “b” value of 36. The pet treat produced using this method has enhanced texture, consistency, palatability, and safety. The method described herein produces a consistently less dense product.

Treatment C: Frozen cut lungs were dehydrated at about 71° C. for 14 hours. The resulting product had a density of 0.1545 g/cm3, and a shear force of 12 Pa. The Hunter lab score was as follows: “L” value 48, “a” value of 15 and a “b” value of 20. The pet treat produced using this method did not have the desired characteristics. The density value was too low and would not provide satisfactory chewing for the companion animal.

Treatment D: Frozen cut lungs were exposed to a first temperature of 204° C., and then dehydrated for 8 hours at 71° C. The resulting product had a density of 0.3219 g/cm3, and a shear force of about 20.2 Pa. The Hunter lab score was as follows: “L” value 33, “a” value of 9 and a “b” value of 15. The pet treat produced using this method did not have the desired characteristics, with a high shear force, the product would be difficult to consume by younger, smaller or elderly companion animals.

TABLE I
Summary of Various Methods and the Results

| | | | Hunter Lab Color | | |
|---|---|---|---|---|---|
| Evaluation of Lung Treatments | Density | Shear | L | a | b |
| Fresh Cut, dehydrated only, | 0.1322 | 4.9* | 39 | 14 | 24 |
| 71° C., 13 hours | | | | | |
| Fresh Cut, Air Fry 30 min at | 0.2756 | 13.9** | 74 | 15 | 36 |
| 204° C., dehydrate 6 hours | | | | | |
| at 71° C. | | | | | |
| Frozen Cut, dehydrated only, | 0.1545 | 12** | 49 | 15 | 20 |
| 71° C., 14 hours | | | | | |
| Frozen Cut, Air Fry 30 min at | 0.3219 | 20.2*** | 33 | 9 | 15 |
| 204° C., dehydrate 8 hours | | | | | |
| at 71° C. | | | | | |

### Example 3

Lung samples were prepared using three different treatment protocols, and tested for pathogen load using Next Generation Sequencing. The samples were tested for both bacterial and viral pathogens.

For treatment #1, fresh porcine lung samples were removed from the lung line, and washed in a cold water bath then sliced. The lung samples were dehydrated at 70°-75° C. for 8 to 10 hours.

For treatment #2, fresh porcine lung samples were removed from the lung line, and washed in a cold water bath. The lungs were exposed to a first temperature ranging from 205° C. to 210° C. for 30 minutes, followed by slicing of the lungs. Finally, the lungs were exposed a second temperature ranging from 70° C. to 75° C. for 6-8 hours (dehydrated).

For treatment #3, fresh porcine lung samples were removed from the lung line, and washed in a cold water bath. The lungs were sliced and exposed to a first temperature ranging from 205° C. to 210° C. for 30 minutes. Finally, the lungs were exposed to a second temperature ranging from 70° C. to 75° C. for 6-8 hours (dehydrated).

### Treatment #1:

A total of 1,112,850 reads were obtained with 91% being of the host (1,015,276 reads), 0.6% bacterial (6,157 reads), and 0.2% viral (2,257). A breakdown of the bacterial and viral reads is provided below.

A. Bacterial Analysis

Predominantly Proteobacteria detected (2552 reads) and Terrabacteria (2080 reads)
Firmicutes (1,669 reads)
   Clostridium (205 reads)
   Listeria (14 reads)
Acinetobacter (1166 reads)
Enterobacteriaceae (183 reads)
   Klebsiella (101 reads)
   E. coli (28 reads)
   Salmonella (18 reads)
Campylobacter (42 reads)

B. Viral

With regard to viral detection, predominantly porcine parvovirus (1404 reads), torque teno virus (502 reads), and bacteteriophage (392 reads) were detected. A break-down of the viral load detected is provided below.
Complete genomes were assembled for porcine parvovirus 4 and an unclassified circular single stranded DNA virus.
Partial genomes were assembled for torque teno virus, porcine parvovirus 2 and porcine parvovirus 7.
No PRRSV, porcine circoviruses, porcine coronaviruses, or portions of these viral genomes were assembled.

### Treatment #2

A total of 1,444,266 reads were obtained with 92% host (1,325,442 reads), 0.7% bacterial (9,666 reads), and 0.05% viral. A summary of the bacterial and viral reads is provided below.

A. Bacterial

Predominantly Terrabacteria detected (3674 reads) and Proteobacteria (3487 reads).
Firmicutes (3,094 reads)
   Clostridium (289 reads)
   Listeria (16 reads)
Acinetobacter (1,386 reads)
Enterobacteriaceae (200 reads)
   E. coli (48 reads)
   Klebsiella (32 reads)
   Salmonella (21 reads)
Campylobacter (43 reads)

B. Viral

0.05% viral (660 reads)
Predominantly bacteriophage (446 reads)
No PRRSV, porcine circoviruses, porcine parvoviruses, porcine coronaviruses or portions of these viral genomes were assembled.

### Treatment #3

A total of 1,086,102 reads were obtained with 92% host (996,408 reads), 0.4% bacterial (4,471 reads) and 0.05% viral. A summary of the bacterial and viral reads is provided below.

A. Bacterial

Predominantly Proteobacteria detected (1719 reads) and Terrabacteria (1723 reads).
Firmicutes (1,349 reads)
   Clostridium (157 reads)
   Listeria (7 reads)
Acinetobacter (390 reads)
Enterobacteriaceae (175 reads)
   Klebsiella (56 reads)
   E. coli (43 reads)
   Salmonella (8 reads)
Campylobacter (26 reads)

B. Viral

0.05% viral (503 reads)
Predominantly bacteriophage (359 reads).
No PRRSV, porcine circoviruses, porcine parvoviruses, porcine coronaviruses or portions of these viral genomes were assembled.

The viral load was greatly reduced when the lung samples were exposed to a first temperature of 205° C. to 210° C. for 30 minutes followed by a second temperature of 70°-75° C. for 8 to 10 hours. When the lung samples were dehydrated only, the viral load was about 0.2% as compared to a viral load of 0.05% obtained in treatments 2 and 3.

In addition to a substantial reduction in viral load, at least 4-fold reduction, the lung samples that were exposed to a first temperature of 205° C. to 210° C. for 30 minutes followed by a second temperature of 70°-75° C. for 8 to 10 hours lacked parvovirus. When the lung samples were dehydrated only, porcine parvovirus was detected. In contrast, parvovirus was not detected in samples exposed to a first and second temperature.

What is claimed is:

1. A method for producing a pet treat comprising:
(a) slicing fresh lungs obtained from a slaughtered animal;
(b) heating the sliced lungs of step (a) for at least 15 minutes, wherein the heating occurs at a temperature from about 205° C. to about 210° C.;
(c) exposing the lungs of steps (b) to a second temperature from about 70° C. to about 75° C. for at least six hours to produce a pet treat.

2. The method of claim 1, wherein the lungs were exposed to a water bath prior to step (a).

3. The method of claim 1, wherein the lungs are from a porcine animal.

4. A pet treat produced by the method of claim 1.

5. A pet treat produced by the method of claim 1 having a density from about 0.22 g/cm³ to about 0.32 g/cm³.

6. A pet treat produced by the method of claim 1 having a shear force from about 10 Pa to about 15 Pa.

7. A pet treat produced by the method of claim 1 having an “L” value on the Hunter scale of at least 65.

8. A method for producing a pet treat comprising:
(a) heating porcine lungs that were not frozen for at least 15 minutes, wherein the heating occurs at a temperature from about 205° C. to about 210° C.;
(b) dehydrating the lungs of step (a) to produce a pet treat.

9. The method of claim 8, wherein the dehydrating step is performed for at least 8 hours.

10. The method of claim 8, wherein the dehydrating step is performed for about 10 hours.

11. The method of claim 8, wherein the heating occurs for about 30 minutes.

12. The method of claim 8, wherein the dehydrating occurs at a temperate from about 70° C. to about 75° C.

13. A pet treat produced by the method of claim 8 having a density of at least about 0.22 g/cm³.

14. A pet treat produced by the method of claim 8 having a shear force no greater than about 15 Pa.

15. A pet treat produced by the method of claim 8 having an “L” value on the Hunter scale of at least 65.

16. A method for producing a pet treat comprising:
(a) removing lungs from an animal;
(b) washing the lungs from step (a) in a water bath;
(c) slicing the lungs from step (b);
(d) heating the sliced lungs from step (c) for at least 15 minutes, wherein the heating occurs at a temperature from about 205° C. to about 210° C.; and
(e) exposing the lungs from step (d) to a second temperature ranging from about 70° C. to about 75° C.

17. The method of claim 16, wherein the heating of step (d) occurs for about 1 hour.

18. The method of claim 16, wherein the washing of step (b) occurs within 4 hours of removing the lungs.

19. A pet treat produced by the method of claim 16 having a density no greater than about 0.32 g/cm³.

20. A pet treat produced by the method of claim 16 having a shear force of at least about 10 Pa.
